(19) United States
(12) Patent Application Publication
(10) Pub. No.: US 2025/0347881 A1
(43) Pub. Date: Nov. 13, 2025

(54) CABLE MANAGER CONFIGURED TO ENHANCE OPERATION OF A TRY PORTION IN A FIBER OPTIC PATCH PANEL

(71) Applicant: BELDEN CANADA ULC, Saint-Laurent (CA)

(72) Inventors: Oscar Alberto LAZARTE BARRIOS, Ville St-Laurent (CA); Christian ROA-QUISPE, LAVAL (CA)

(73) Assignee: BELDEN CANADA ULC, Saint-Laurent (CA)

(21) Appl. No.: 19/202,698

(22) Filed: May 8, 2025

Related U.S. Application Data
(60) Provisional application No. 63/643,996, filed on May 8, 2024.

(51) Int. Cl. G02B 6/44

(52) U.S. Cl. CPC G02B 6/44524

(57) ABSTRACT

A fiber cable manager may have a body portion that may couple a tray portion with a rack portion of a fiber optic patch panel. The body portion may have a cable retaining portion that may retain a cable portion such that the cable portion extends through the body portion. The body portion may have a surface portion that extends in the longitudinal direction and may have a cable receiving portion that may be urged in a direction transverse direction, from a rest position to a deformed position. The body portion may maintain the cable receiving portion in the rest position in response to a longitudinal force being applied to the body portion such that the body portion may move relative to the rack portion with the cable receiving portion in the rest position so as to enhance operation of a tray portion in a fiber optic patch panel.

### CROSS REFERENCE TO RELATED APPLICATION

This application claims the benefit of U.S. Provisional Application No. 63/643,996, filed May 8, 2024, which is currently pending, the disclosure of which is hereby incorporated by reference herein in its entirety.

### TECHNICAL FIELD

The present disclosure is directed to a cable manager and, more particularly, to a system for increasing efficiency of a sliding component of a distributed network.

### BACKGROUND

Data and other digital signals are becoming more prominent aspects of daily life. While previously isolated to certain industries, such as academic or commercial, the generation, transfer, and storage of digital information has become commonplace. For instance, mobile devices and wireless connectivity of sensors and devices create pictures, text, and signals that are transferred, processed, and stored as part of a distributed network.

As distributed networks advance to greater sophistication and capabilities, complexity may occur and produce inefficiencies in the maintenance and/or alteration of aspects of the components that enable digital signal transfer and storage. The presence of greater numbers of network components can provide increased capabilities but may introduce disorganization and increased maintenance tasks that reduce the ability to utilize peak performance from some network components.

With these issues in mind, it may be desirable to provide a fiber cable manager configured so as to enhance operation of a tray portion in a fiber optic patch panel. In some aspects, it may be desirable to organize cables of a distributed network while allowing efficient one-handed engagement of some network components.

### SUMMARY

In accordance with various aspects of the disclosure, a fiber cable manager may be a fiber cable manager may be configured to enhance operation of a tray portion in a fiber optic patch panel with a body portion that may be configured to couple a tray portion with a rack portion of a fiber optic patch panel. The body portion may have an attachment portion that may couple with the tray portion such that the tray portion that may move with the body portion. The body portion may slidingly move relative to the rack portion in a longitudinal direction. The body portion may be disposed between the rack portion and the tray portion in a first direction transverse to the longitudinal direction. The body portion may have a cable retaining portion at a first end of the body portion in the longitudinal direction that is structurally configured to that may retain a cable portion such that the cable portion extends through the body portion in the first direction. The body portion may have a surface portion that extends in the longitudinal direction and may have a cable receiving portion that may be urged in a second direction, transverse to the longitudinal direction, from a rest position to a deformed position. The rest position of the cable receiving portion may prevent a cable portion from being placed in, and removed from, the cable retaining portion, and the deformed position may permit a cable portion to be placed in, and removed from, the cable retaining portion. The cable retaining portion may have an end wall portion at a first end of the body portion that extends in the second direction. The body portion may have a gripping portion that extends from the end wall portion in the longitudinal direction. The body portion may maintain the cable receiving portion in the rest position in response to a longitudinal force being applied to the gripping portion such that the body portion may move relative to the rack portion in the longitudinal direction with the cable receiving portion in the rest position so as to enhance operation of a tray portion in a fiber optic patch panel.

In some embodiments of the aforementioned fiber cable manager, the attachment portion may comprise a protrusion extending from the body portion.

In some embodiments of the aforementioned fiber cable managers, the attachment portion may comprise a plurality of protrusions each extending from the body portion.

In some embodiments of the aforementioned fiber cable managers, the body portion may comprise a plurality of cable retention portions.

In some embodiments of the aforementioned fiber cable managers, each cable retention portion may comprise a cable receiving portion.

In some embodiments of the aforementioned fiber cable managers, the cable receiving portion may be structurally configured to be asymmetrical along a plane orthogonal to the longitudinal direction.

In some embodiments of the aforementioned fiber cable managers, the cable receiving portion may be structurally configured to separate portions of a top portion of the body portion.

In some embodiments of the aforementioned fiber cable managers, the cable retention portion may be structurally configured to be defined by the top portion and a bottom portion of the body portion.

In some embodiments of the aforementioned fiber cable managers, the bottom portion may continuously extend along the longitudinal direction throughout the cable retention portion.

In accordance with various aspects of the disclosure, a fiber cable manager may enhance operation of a tray portion in a fiber optic patch panel with a body portion that may couple a tray portion with a rack portion of a fiber optic patch panel. The body portion may have an attachment portion that may couple with the tray portion such that the tray portion may move with the body portion. The body portion may slidingly move relative to the rack portion in a longitudinal direction. The body portion may have a cable retaining portion at a first end of the body portion in the longitudinal direction that may retain a cable portion such that the cable portion extends through the body portion in the first direction. The body portion may have a surface portion that extends in the longitudinal direction and may have a cable receiving portion that may be urged in a second direction, transverse to the longitudinal direction, from a rest position to a deformed position. The rest position of the cable receiving portion may prevent a cable portion from being placed in and removed from the cable retaining portion. The deformed position may permit a cable portion to be placed in, and removed from, the cable retaining portion. The body portion may maintain the cable receiving portion in the rest position in response to a longitudinal force being applied to the body portion such that the body portion may move relative to the rack portion in the longitudinal direction with the cable receiving portion in the rest position so as to enhance operation of a tray portion in a fiber optic patch panel.

In some embodiments of the aforementioned fiber cable managers, the body portion may be configured to be disposed between the rack portion and the tray portion in a first direction transverse to the longitudinal direction.

In some embodiments of the aforementioned fiber cable managers, the body portion may include a gripping portion that extends from the end wall portion in the longitudinal direction.

In some embodiments of the aforementioned fiber cable managers, the cable retaining portion may include an end wall portion at a first end of the body portion that extends in the second direction.

In some embodiments of the aforementioned fiber cable managers, the body portion may be structurally configured with multiple separate cable retaining portions positioned at the first end of the body portion

In accordance with various aspects of the disclosure, a fiber cable manager may enhance operation of a tray portion in a fiber optic patch panel with a body portion that may couple a tray portion with a rack portion of a fiber optic patch panel. The body portion may have a cable retaining portion at a first end of the body portion in the longitudinal direction that may retain a cable portion such that the cable portion extends through the body portion in the first direction. The body portion may have a surface portion that extends in the longitudinal direction and may have a cable receiving portion that may be urged in a second direction, transverse to the longitudinal direction, from a rest position to a deformed position. The rest position of the cable receiving portion may prevent a cable portion from being placed in, and removed from, the cable retaining portion. The deformed position may permit a cable portion to be placed in, and removed from, the cable retaining portion. The body portion may maintain the cable receiving portion in the rest position in response to a longitudinal force being applied to the gripping portion such that the body portion may move relative to the rack portion in the longitudinal direction with the cable receiving portion in the rest position so as to enhance operation of a tray portion in a fiber optic patch panel.

In some embodiments of the aforementioned fiber cable managers, the body portion may be structurally configured to slidingly move relative to the rack portion in a longitudinal direction.

In some embodiments of the aforementioned fiber cable managers, the body portion may include an attachment portion structurally configured to couple with the tray portion such that the tray portion is configured to move with the body portion.

In some embodiments of the aforementioned fiber cable managers, the cable receiving portion may be structurally configured to concurrently retain multiple separate cable portions.

In some embodiments of the aforementioned fiber cable managers, the body portion may be structurally configured with a tab portion arranged to promote an application of force in the transverse direction deforming the cable retaining portion.

In some embodiments of the aforementioned fiber cable managers, the tab portion may be structurally configured to extend from the first end of the body portion

### BRIEF DESCRIPTION OF THE DRAWINGS

Further advantages and features of the present disclosure will become apparent from the following description and the accompanying drawings, to which reference is made.

FIG. 1 is a line representation of portions of a distributed signal network in which assorted embodiments of a fiber cable manager may be practiced.

FIG. 2 is a line representation of portions of a cable assembly that may be employed in the distributed signal network of FIG. 1.

FIG. 3 is a perspective view of portions of a fiber cable manager configured in accordance with various embodiments of this disclosure.

FIG. 4 is a perspective view of portions of a fiber cable manager arranged in accordance with various embodiments of this disclosure.

FIG. 5 is a perspective view of portions of a fiber cable manager configured in accordance with various embodiments of this disclosure.

FIG. 6 is a line representation of portions of a fiber cable manager arranged in accordance with various embodiments of this disclosure.

FIG. 7 is a line representation of portions of a fiber cable manager configured in accordance with various embodiments of this disclosure.

FIG. 8 is a line representation of portions of a fiber cable manager arranged in accordance with various embodiments of this disclosure.

### DETAILED DESCRIPTION

Embodiments provide a fiber cable manager configured to enhance operation of a tray portion in a fiber optic patch panel.

Reference will now be made in detail to presently preferred embodiments and methods of the present disclosure, which constitute the best modes of practicing the present disclosure presently known to the inventors. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

In an effort to meet demand for reliable, fast signal pathways that provide a distributed network, electronic devices are employed, often in mass quantities. Advancements in the generation, transfer, and storage of digital information have emphasized the organization and efficiency of cabling involved with operation of electronic devices. Conventional distributed network physical configurations have focused on density rather than physical access, visual access, or cable management. As such, various embodiments of a distributed network physically arrange network components with a fiber cable manager that concurrently increases the efficiency of cable organization and physical access to a sliding tray of network components.

FIG. 1 conveys a block representation of portions of a distributed signal network 100 in which various embodiments of a tab system may be practiced. An interconnect 110 electronic device, such as, for example, a switch, server, splitter, amplifier, filter, or other circuitry, may provide stable, continuous signal pathways between signal sources 120 and signal destinations 130. An interconnect 110 can have any number, and type, of port that allows selective electrical engagement of a cable with other cables. That is, an interconnect 110 may physically and electrically connect to multiple different cables that employ different, or matching, signal carrying portions, such as, for example, a coaxial conductor or optical conduit, to from a signal pathway that may be utilized for transferring signals in one or more directions between sources 120 and destinations 130.

The interconnect 110 may provide ports structurally configured to engage one or more cables to provide a connection between a source 120 and a destination 130. For instance, a single input port 140 may connect to a single cable with a single output port 150 to provide two-way signal communication. The interconnect 110 may allow multiple cables to interact with separate ports 140/150 to communicate signals. However, other ports of the interconnect 110 may be arranged to provide duplex 160 or quad 170 configurations where multiple separate cables connect to separate ports to provide concurrently dedicated one-way communication between a selected source 120 and destination 130.

Through the use of an interconnect 110, separate signal carrying cables may be utilized to form static, or dynamic, signal pathways that enable robust communications between local, or remote, sources 120 and destinations 130. As illustrated in the cable assembly 200 of FIG. 2, a number of separate interconnects 110 may be physically mounted with a relatively high density inside a mount portion 210, for example, a rack portion of a patch panel. Each interconnect 110 is positioned within a tray region 212 between a pair of rail portions 220. Some embodiments structurally configure the tray region 212 with more than one interconnect 110 and with the rail portions 220 providing sliding capabilities for one or more of the interconnects 110 positioned in the tray region 212.

The ability to configure the mount portion 210 with any number and type of interconnects 110 may provide high volumes of connectivity. An interconnect port 140 may be any configuration to electrically couple to a cable portion 230. Some embodiments arrange a cable portion 230 with a selectable connector 240 that allows for physical retention of the cable in the port 140/150/160/170 for a desired amount of time. As greater volumes of ports are engaged with cable portions 230, physical and visual access may be restricted. For instance, the presence of connected cable portions 230 can obscure visual access to labels 250 as well as physical access to other ports, such as ports of other interconnects 110 positioned lower on the mount portion 210.

The presence of cables 230 may additionally restrict movement of an interconnect 110 within the mount portion 210. As a non-limiting example, cables 230 connected to an interconnect 110, or an adjacent interconnect within the mount portion 210, can inhibit the interconnect 110 from sliding into, and out of, the mount portion 210. Hence, the greater number of ports available in an interconnect 110, and mount portion 210, may pose cable 230 organization and management difficulties along with degraded physical and/or visual access to the assorted interconnects 110 of a mount portion 210.

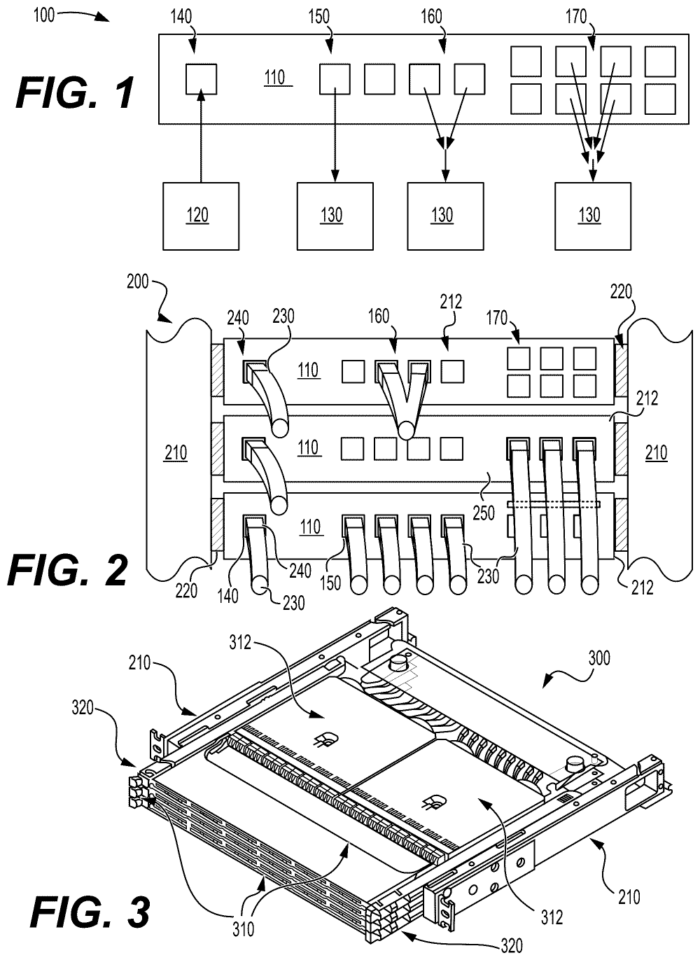

FIG. 3 illustrates a perspective view of a cable assembly 300 that employs a mount portion 210 with multiple stacked tray portions 310 each occupied by components, for example, fiber optic equipment. As illustrated, the fiber optic equipment may include a cassette portion 312 that, in some embodiments, comprises a plurality of fiber optic cassettes or microcassettes. As shown, the cassette portion 312 may occupy a tray portion 310 may collectively slide relative to the mount portion 210 via body portions 320. The body portions 320 may be structurally configured with any movement mechanism, such as, for example, bearings, grooves, springs, or expandable protrusions, attached to opposite sides of the cassette portion 312. Some embodiments attach a cassette portion 312 to a rigid tray feature that is coupled to the respective body portions 320 instead of the cassette portion 312 being directly coupled to the body portions 320.

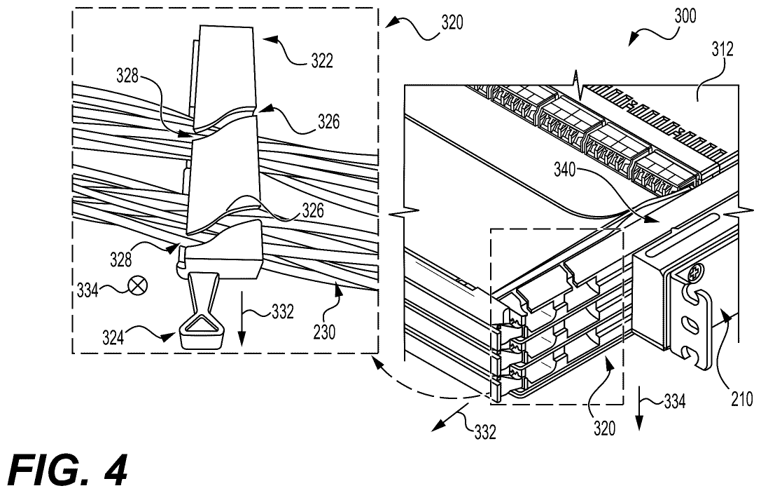

The body portions 320 may respectively provide cable organization and management while increasing physical access efficiency with tab portions that promote tactile access and allows one-handed engagement of the tray portion 310. FIG. 4 illustrates aspects of the cable assembly 300 with greater clarity than FIG. 3. Specifically, the body portions 320 associated with each tray portion 310 are shown with increased detail in both how they are arranged and how they operate to allow the respective cassette portions 312 of each tray portion 310 to slide with respect to a rack portion 210.

In the picture to the left of FIG. 4, a portion of a single body portion 320 is displayed. It is noted that a full body portion 320, such as the body portions 320 shown in FIG. 3, may extend for greater lengths than the example shown in the picture of FIG. 4. The body portion 320, in accordance with various embodiments, may have a unitary structure configured to present a gripping portion 324, such as a cantilevered tab feature, that protrudes to provide a gripping feature as well as a receiving portion, for example, cable retaining portions 326 may include an end wall portion 440 at a first end of the body portion 320 and may be configured to allow cable portions 230 to pass through the body portion 320 between a top portion and a bottom portion of the body portion 320.

The body portion top portion 322 is further structurally configured, in some embodiments, to be substantially rigid in response to force in a longitudinal direction 332 and substantially flexible in a transverse direction 334. The body portion 320, and particularly the top portion 322, may be characterized as a surface portion, with a configuration that extends in the longitudinal direction and includes a cable receiving portion 328 that is structurally configured to be urged in a second direction, transverse to the longitudinal direction, to provide a rest position and a deformed position.

Such flexibility allows the cable retaining portions 326 to be efficiently enlarged and accessed by simply applying force in the transverse direction 334. The material of the body portion 320, such as the continuous and uninterrupted bottom portion of the body portion 320 throughout the longitudinal direction, and the structural configuration of the respective cable retaining portions 326 allow for reliable cable portion 230 retention over time due to the elastic nature of the body portion 320 that temporarily flexes in response to transverse force before returning to the arrangement shown in FIG. 4.

The ability to provide flexibility and rigid behavior in response to different applied force directions allows the body portion 320 to provide efficient movement of a tray region 212, and constituent cassette portion(s) 312, along with efficient cable 230 management with the respective cable retaining portions 326. Although body portion 320 is shown in FIG. 4 with two separated cable retaining portions 326 with matching sizes and shapes, such structural configuration is not required or limiting. For instance, one cable retaining portion 326 may be arranged to fit less cable portions 230 than another cable opening.

Another non-limiting example of the cable retention portion 326 may arrange the cable receiving portion 328 of separate cable retaining portions 326 differently, which can provide different mechanical response to force and cater to efficient insertion of cables 230 with a selected diameter, such as 2 mm, 4 mm, 8 mm, or greater. In other words, by customizing the size, shape, and position of a cable receiving portion 328, operation of a cable retaining portion 326 can be customized to provide desired response to transverse force, such as, for example, ease of cable 230 insertion or cable 230 freedom of movement while in a cable retaining portion 326. In some embodiments, the cable receiving portion 328 is configured to be asymmetrical along a plane orthogonal to the longitudinal direction 332.

Once cable portions 230 are positioned in the cable retaining portions 326, as shown in FIG. 4, after passing through the cable receiving portions 328, the cable receiving portion 328 may be in a rest position that may prevent a cable portion 230 from being placed in, and removed from, the cable retaining portion 326. Some embodiments may configure the cable retaining portion 326 to have a deformed position that may permit a cable portion 230 to be placed in, and removed from, the cable retaining portion 326 by expanding, or otherwise altering, the cable receiving portion 328.

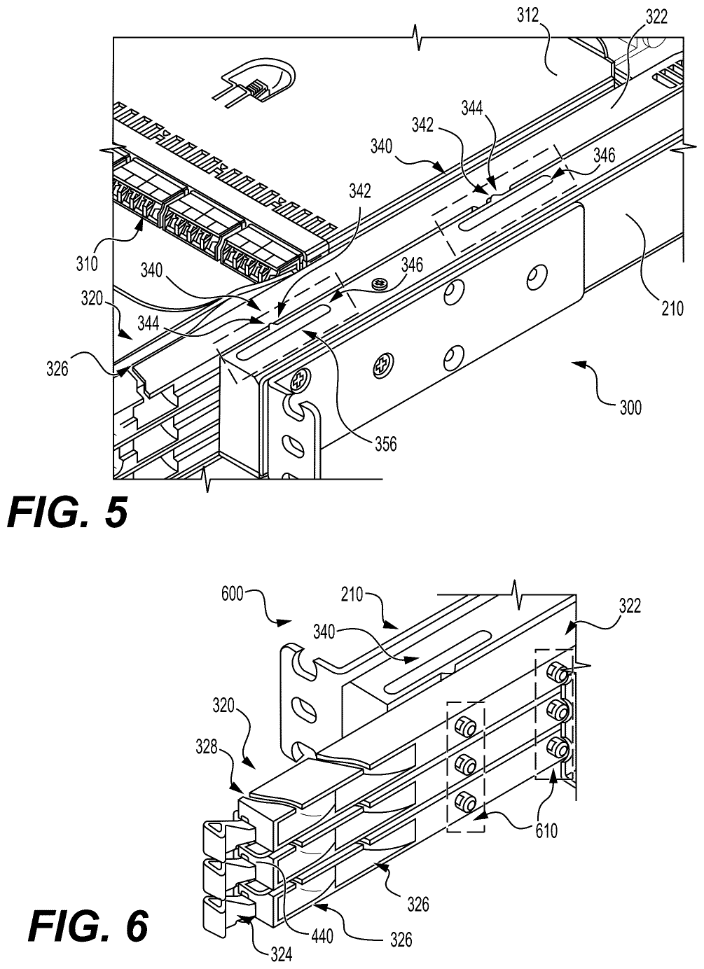

The rail portion body 322 may additionally be structurally configured with one or more soft stop portions 340 that provide increased body portion 320 retention at selected sliding distances relative to the rack portion 210. An example soft stop portion 340 is illustrated in FIG. 4 while FIG. 5 conveys how a body portion 320 may have multiple separate soft stop portions 340 to provide greater physical retention and, potentially, multiple sliding positions of the tray portion 310 relative to the rack portion 210.

The line representation of FIG. 5 illustrates how each soft stop portion 340 is structurally configured with a flex protrusion portion 342 that engages a rigid land portion 344 of the rail portion body 322. A relief portion 346 presents an aperture that corresponds with an amount of movement for the flex protrusion portion 342 in response to sliding the land portion 344 into contact with the flex protrusion portion 342. Such flexing of the flex protrusion portion 342 operates to increase friction resisting body portion 320 followed by rail portion body 322 retention as the flex protrusion portion 342 moves to occupy a notch aspect of the land portion 344.

The presence of multiple separate soft stop portions 340 may further increase the strength of physical retention of the body portion 320 by the respective flex protrusion portions 342. In practice, the soft stop portions 340 allow a technician to reliably move one or more tray regions 212 out of the rack portion 210 and retain the body portion 320 in place over time. The strength of the soft stop portions 340, which can be customized with the shape and size of the relief portions 346, such as an aperture 356, allows the position of the tray region 212, and body portion 320, to be maintained despite external force. As a result, a technician can efficiently apply force to install, or remove, cables 230 into the cable retaining portions 326 and/or interconnect ports without the tray region 212 inadvertently moving into, or out of, the rack portion 210.

The combination of material construction and geometrical optimization of the soft stop portion 340, the functional life span of the tray portion 310 operation may be increased. That is, the assorted aspects of the soft stop portion 340 may provide greater operational cyclic reliability compared to other manual or automatic features that catch, stop, or otherwise add friction to a sliding mechanism at selected locations. As a non-limiting example, a catch mechanism that does not allow for material flexing or movement may have a relatively low cyclic lifespan, such as less than one hundred sliding engagements, while the structural configuration of various embodiments of the soft stop portion 340 may provide, for example, over two hundred sliding engagements with 99% of initial structural retention strength.

While the tray portion 310 may be occupied solely by cassette portions 312 in some embodiments, other embodiments utilize the body portions 320 to mount additional attachments within a rack portion 210. FIGS. 6-8 illustrate portions of a cable assembly 600 structurally configured in accordance with various embodiments to provide modular attachment capabilities. FIG. 6 displays how each rail portion body top portion 322 has an attachment portion 610 that may be cantilevered protrusion, such as square, circular, or hexagonal structure, that may be selectively engaged by any number, and type, of physical accessories. In some aspects, the attachment portion 610 may include a plurality of attachment portions 610.

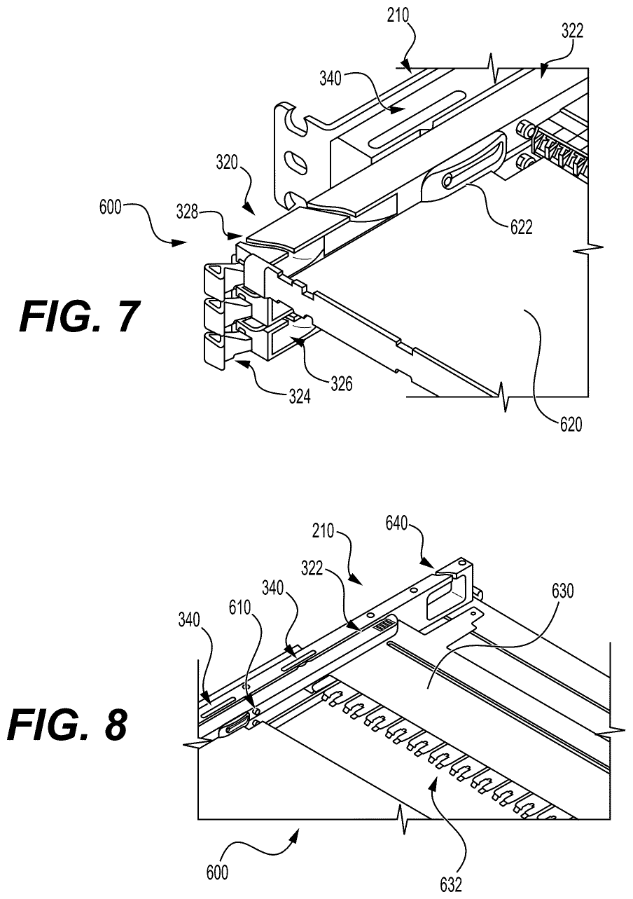

FIG. 7 displays how an attachment portion 610 may be employed to physically support a tray portion 620. It is contemplated, but not required, that the tray portion 620 provides physical support, and protection, for cables running from the cable openings 326 to the respective interconnect ports. As shown, the tray portion 620 is structurally configured with a keyed slot 622 that may control the movement of the tray portion 620 relative to the rail portion body top portion 322. Such a tray portion 620 may additionally provide cooling and/or environmental operation that benefits the performance, reliability, or security of the adjacent cassette portions 312.

FIG. 8 illustrates portions of the cable assembly 600 utilizing a different tray feature 630 in accordance with various embodiments. The tray feature 630 has a number of matching connection tabs 632 that may provide cable retention and organization. It is noted that the tray feature 630 of FIG. 8 does not attach to the attachment portion 610 but, instead, is mounted directly onto the rail portion body 322. The mount portion 210 may be arranged with a rear cable opening 640, which may allow access to a different aspect of the tray feature 630 than cable openings 326 positioned adjacent to the front of the tray feature 630. Such mounting may involve any number, type, and position of fasteners, such as rivets, screws, pins, keyed protrusions, or adhesives, that allow the body portion 320 to maintain a sliding relationship with the mount portion 210.

Additional embodiments include any one of the embodiments described above, where one or more of its components, functionalities or structures is interchanged with, replaced by or augmented by one or more of the components, functionalities or structures of a different embodiment described above. It should be understood that various changes and modifications to the embodiments described herein will be apparent to those skilled in the art. Such changes and modifications can be made without departing from the spirit and scope of the present disclosure and without diminishing its intended advantages. It is therefore intended that such changes and modifications be covered by the appended claims.

Although several embodiments of the disclosure have been disclosed in the foregoing specification, it is understood by those skilled in the art that many modifications and other embodiments of the disclosure will come to mind to which the disclosure pertains, having the benefit of the teaching presented in the foregoing description and associated drawings. It is thus understood that the disclosure is not limited to the specific embodiments disclosed herein above, and that many modifications and other embodiments are intended to be included within the scope of the appended claims. Moreover, although specific terms are employed herein, as well as in the claims which follow, they are used only in a generic and descriptive sense, and not for the purposes of limiting the present disclosure, nor the claims which follow.

What is claimed is:

1. A fiber cable manager configured to enhance operation of a tray portion in a fiber optic patch panel comprising:
a body portion structurally configured to couple a tray portion with a rack portion of a fiber optic patch panel;
wherein the body portion includes an attachment portion structurally configured to couple with the tray portion such that the tray portion is configured to move with the body portion;
wherein the body portion is structurally configured to slidingly move relative to the rack portion in a longitudinal direction;
wherein the body portion is configured to be disposed between the rack portion and the tray portion in a first direction transverse to the longitudinal direction;
wherein the body portion includes a cable retaining portion at a first end of the body portion in the longitudinal direction that is structurally configured to retain a cable portion such that the cable portion extends through the body portion in the first direction;
wherein the body portion includes a surface portion that extends in the longitudinal direction and includes a cable receiving portion that is structurally configured to be urged in a second direction, transverse to the longitudinal direction, from a rest position to a deformed position;
wherein the rest position of the cable receiving portion is configured to prevent a cable portion from being placed in and removed from the cable retaining portion, and wherein the deformed position is configured to permit a cable portion to be placed in and removed from the cable retaining portion;
wherein the cable retaining portion includes an end wall portion at a first end of the body portion that extends in the second direction;
wherein the body portion includes a gripping portion that extends from the end wall portion in the longitudinal direction; and
wherein the body portion is structurally configured to maintain the cable receiving portion in the rest position in response to a longitudinal force being applied to the gripping portion such that the body portion is configured to move relative to the rack portion in the longitudinal direction with the cable receiving portion in the rest position so as to enhance operation of a tray portion in a fiber optic patch panel.

2. The fiber cable manager of claim 1, wherein the attachment portion comprises a protrusion extending from the body portion.

3. The fiber cable manager of claim 1, wherein the attachment portion comprises a plurality of protrusions each extending from the body portion.

4. The fiber cable manager of claim 1, wherein the body portion comprises a plurality of cable retention portions.

5. The fiber cable manager of claim 4, wherein each cable retention portion comprises a cable receiving portion.

6. The fiber cable manager of claim 5, wherein the cable receiving portion is structurally configured to be asymmetrical along a plane orthogonal to the longitudinal direction.

7. The fiber cable manager of claim 5, wherein the cable receiving portion is structurally configured to separate portions of a top portion of the body portion.

8. The fiber cable manager of claim 7, wherein the cable retention portion is structurally configured to be defined by the top portion and a bottom portion of the body portion.

9. The fiber cable manager of claim 8, wherein the bottom portion continuously extends along the longitudinal direction throughout the cable retention portion.

10. A fiber cable manager configured to enhance operation of a tray portion in a fiber optic patch panel comprising:
a body portion structurally configured to couple a tray portion with a rack portion of a fiber optic patch panel;
wherein the body portion includes an attachment portion structurally configured to couple with the tray portion such that the tray portion is configured to move with the body portion;
wherein the body portion is structurally configured to slidingly move relative to the rack portion in a longitudinal direction;
wherein the body portion includes a cable retaining portion at a first end of the body portion in the longitudinal direction that is structurally configured to retain a cable portion such that the cable portion extends through the body portion in a first direction;
wherein the body portion includes a surface portion that extends in the longitudinal direction and includes a cable receiving portion that is structurally configured to be urged in a second direction, transverse to the longitudinal direction, from a rest position to a deformed position;
wherein the rest position of the cable receiving portion is configured to prevent a cable portion from being placed in and removed from the cable retaining portion, and wherein the deformed position is configured to permit a cable portion to be placed in and removed from the cable retaining portion; and
wherein the body portion is structurally configured to maintain the cable receiving portion in the rest position in response to a longitudinal force being applied to the body portion such that the body portion is configured to move relative to the rack portion in the longitudinal direction with the cable receiving portion in the rest position so as to enhance operation of a tray portion in a fiber optic patch panel.

11. The fiber cable manager of claim 10, wherein the body portion is configured to be disposed between the rack portion and the tray portion in a first direction transverse to the longitudinal direction.

12. The fiber cable manager of claim 10, wherein the body portion includes a gripping portion that extends from the end wall portion in the longitudinal direction.

13. The fiber cable manager of claim 10, wherein the cable retaining portion includes an end wall portion at a first end of the body portion that extends in the second direction.

14. The fiber cable manager of claim 10, wherein the body portion is structurally configured with multiple separate cable retaining portions positioned at the first end of the body portion.

15. A fiber cable manager configured to enhance operation of a tray portion in a fiber optic patch panel comprising:
a body portion structurally configured to couple a tray portion with a rack portion of a fiber optic patch panel;
wherein the body portion includes a cable retaining portion at a first end of the body portion in the longitudinal direction that is structurally configured to retain a cable portion such that the cable portion extends through the body portion in the first direction;
wherein the body portion includes a surface portion that extends in the longitudinal direction and includes a cable receiving portion that is structurally configured to be urged in a second direction, transverse to the longitudinal direction, from a rest position to a deformed position;
wherein the rest position of the cable receiving portion is configured to prevent a cable portion from being placed in and removed from the cable retaining portion, and wherein the deformed position is configured to permit a cable portion to be placed in and removed from the cable retaining portion; and
wherein the body portion is structurally configured to maintain the cable receiving portion in the rest position in response to a longitudinal force being applied to the body portion such that the body portion is configured to move relative to the rack portion in the longitudinal direction with the cable receiving portion in the rest position so as to enhance operation of a tray portion in a fiber optic patch panel.

16. The fiber cable manager of claim 15, wherein the body portion is structurally configured to slidingly move relative to the rack portion in a longitudinal direction.

17. The fiber cable manager of claim 15, wherein the body portion includes an attachment portion structurally configured to couple with the tray portion such that the tray portion is configured to move with the body portion.

18. The fiber cable manager of claim 15, wherein the cable receiving portion is structurally configured to concurrently retain multiple separate cable portions.

19. The fiber cable manager of claim 15, wherein the body portion is structurally configured with a tab portion arranged to promote an application of force in the transverse direction deforming the cable retaining portion.

20. The fiber cable manager of claim 19, wherein the tab portion is structurally configured to extend from the first end of the body portion.
